(19) United States
(12) Patent Application Publication
(10) Pub. No.: US 2013/0293547 A1
(43) Pub. Date: Nov. 7, 2013

(54) GRAPHICS RENDERING TECHNIQUE FOR AUTOSTEREOSCOPIC THREE DIMENSIONAL DISPLAY

(71) Applicants: Yangzhou Du, Beijing (CN); Qiang Li, Beijing (CN)

(72) Inventors: Yangzhou Du, Beijing (CN); Qiang Li, Beijing (CN)

(21) Appl. No.: 13/976,015

(22) PCT Filed: Dec. 7, 2011
(86) PCT No.: PCT/US11/63835

§ 371 Date: Jun. 25, 2013

(51) Int. Cl. G06T 15/06

(52) U.S. Cl. CPC G06T 15/06
USPC 345/426

(57) ABSTRACT

Various embodiments are presented herein that may render an image frame on an autostereoscopic 3D display. A computer platform including a processor circuit executing a rendering application may determine a current orientation of a virtual camera array within a three-dimensional (3D) scene and at least on additional 3D imaging parameter for the 3D scene. The rendering application, with the aid of a ray tracing engine, may also determine a depth range for the 3D scene. The ray tracing engine may then facilitate rendering of the image frame representative of the 3D scene using a ray tracing process.

### BACKGROUND

Current implementations for rendering three-dimensional (3D) images on an autostereoscopic 3D display keep the rendering procedure independent from a sub-pixel interleaving procedure. Multi-view rendering is done first followed by interleaving the multi-view images according to a certain sub-pixel pattern. The time required for multi-view rendering is proportional to the number of views. Thus, real-time 3D image rendering or interactive rendering is very difficult on consumer-level graphics hardware. Accordingly, there may be a need for improved techniques to solve these and other problems.

### BRIEF DESCRIPTION OF THE DRAWINGS

FIG. 1 illustrates an example lenticular array and a corresponding sub-pixel interleaving format for a multi-view autostereoscopic 3D display.

FIG. 2 illustrates a sample pixel grouping according to embodiments of the invention.

FIG. 3 illustrates a sample space for a 3D scene.

FIG. 4 illustrates one embodiment of an architecture suitable to carry out embodiments of the disclosure.

FIG. 5 illustrates one embodiment of a rendering application functional diagram.

FIG. 6 illustrates one embodiment of a logic flow.

FIG. 7 illustrates an embodiment of a system that may be suitable for implementing embodiments of the disclosure.

FIG. 8 illustrates embodiments of a small form factor device in which the system of FIG. 7 may be embodied.

### DETAILED DESCRIPTION

Various embodiments are presented herein that may render an image frame on an autostereoscopic 3D display. A computer platform including a processor circuit executing a rendering application may determine a current position and orientation of a virtual camera array within a three-dimensional (3D) scene and at least one additional 3D imaging parameter for the 3D scene. The additional 3D imaging parameters may include a baseline length for the virtual camera array as well as a focus point for the virtual camera array. The rendering application, with the aid of a ray tracing engine, may also determine a depth range for the 3D scene. The ray tracing engine may then facilitate rendering of the image frame representative of the 3D scene using a ray tracing process.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

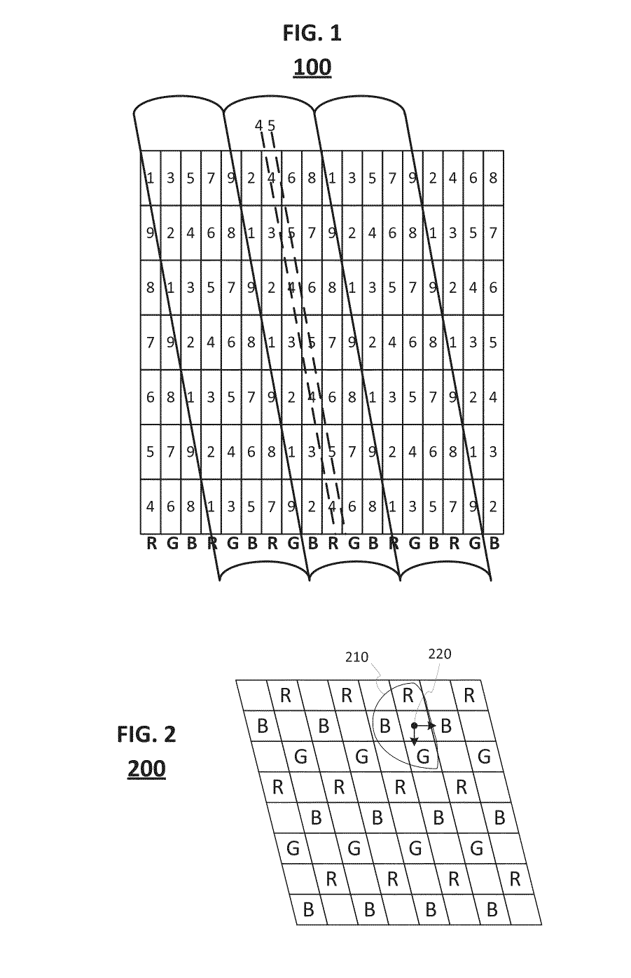

Autostereoscopy is any method of displaying stereoscopic images (adding binocular perception of 3D depth) without the use of special headgear or glasses on the part of the viewer. Many autostereoscopic displays are multi-view displays. FIG. 1 illustrates the structure of a slanted sheet of lenticular array on the top of an LCD panel and the corresponding sub-pixel interleaving format for a multi-view (e.g., nine) autostereoscopic 3D display. A group of adjacent red (R), green (G), and blue (B) color components form a pixel while each color component comes from a different view of the image, as indicated by the number inside each rectangle. The dashed lines labeled “4” and “5” indicate the RGB color components for the given view. If a conventional rasterization rendering technique were implemented, nine (9) separate images (one for each view) would need to be rendered and then interleaved according to a specific format. The processing time in the graphics pipeline is proportional to the number of views. Thus, the rendering time will also be largely proportional to the number of views making it very difficult to achieve real-time rendering with conventional graphics hardware.

However, the total number of pixels remains unchanged for the multi-view 3D display. The rendering time using ray tracing is proportional to the number of issued rays (e.g., pixels). Therefore, the rendering performance is independent of the number of views. This means that the rendering performance keeps is the same for rendering in autostereoscopic 3D as it is for rendering in two-dimensional (2D) resolution.

When rendering a given view, red (R), green (G), and blue (B) color components form pixel groups 210 as shown in FIG. 2. The center 220 of a grouping of pixels in is not necessarily located at integer coordinates. A ray tracing engine supports issuing rays from a non-integer positioned center pixel, and filling the determined pixel color in the specific location of a frame buffer. When all sub-pixels are filled in the frame buffer, the number of issued rays will be exactly equal to the total number of pixels. However, if conventional rendering such as, for instance, rasterization is used, additional interpolation operations will be required to obtain the accurate color of pixels at non-integer coordinates. This would incur significant additional overhead when compared to single view image rendering.

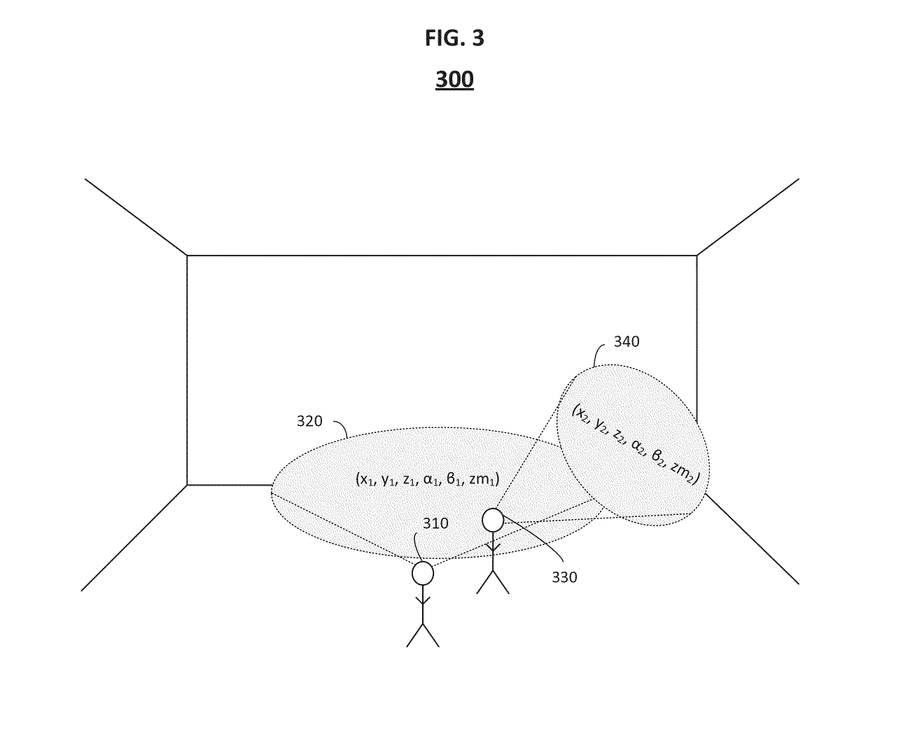

FIG. 3 illustrates a sample space 300 for a 3D scene. The sample space 300 may be illustrative of a character or avatar within a video game. The avatar may be representative of a player of the video game. The perspective of the avatar may be represented by a virtual camera array. This example is intended to show a change in perspective based on motion of the avatar between frames. A first virtual camera array 310 is positioned and oriented according to the perspective of the avatar in a first frame. The virtual camera array 310 may be capable of illustrating or “seeing” a field of view 320 based on a number of imaging parameters. The imaging parameters may include an (x, y, z) coordinate location, an angular left/right viewing perspective (a) indicative of virtual camera array panning, an up/down viewing perspective ( [symbol] ) indicative of virtual camera array tilting, and a zooming in/out perspective (zm) indicative of a magnification factor. The various coordinate systems and positional representations are illustrative only. One of ordinary skill in the art could readily implement additional or alternative positional and orientational information without departing from the scope of the embodiments herein. The embodiments are not limited in this context.

In the example of FIG. 3, the first virtual camera array 310 may be associated with the imaging parameter set (x₁, y₁, z₁, α₁, [symbol] ₁, zm₁). The x₁, y₁, z₁ coordinates may define the point in space where the first virtual camera array 310 is currently positioned. The α₁, [symbol] ₁ parameters may define the orientation of the first virtual camera array 310. The orientation α₁, [symbol] ₁ parameters may describe the direction and the elevation angle the first virtual camera array 310 is oriented. The zm₁ parameter may describe the magnification factor at which the first virtual camera array 310 is currently set. For instance, the avatar may be using binoculars at this instance to increase the zoom factor. All of the imaging parameters combine to create a field of view 320 for the first virtual camera array 310. The field of view 320 may be representative of a 3D scene within the game which must be rendered as a frame on a display for the player of the video game.

The second virtual camera array 330 may be representative of a new field of view 340 after the player of the video game has provided user input altering the perspective or vantage point of the avatar. To render the altered 3D scene as a frame for the player of the video game, the new imaging parameters must be determined and used. The second virtual camera array 330 may be associated with the imaging parameter set (x₂, y₂, z₂, α₂, [symbol] ₂, zm₂). The x₂, y₂, z₂ coordinates may define the point in space where the second virtual camera array 330 is currently positioned. The α₂, [symbol] ₂ parameters may define the orientation of the second virtual camera array 330. The orientation α₂, [symbol] ₂ parameters may describe the direction and the elevation angle the second virtual camera array 330 is oriented. The zm₂ parameter may describe the magnification factor at which the second virtual camera array 330 is currently set. For instance, the avatar may be using binoculars at this instance to increase the zoom factor. All of the imaging parameters combine to create the new field of view 340 for the second virtual camera array 330. The new field of view 340 may be representative of a 3D scene within the game which must be rendered as the next frame on a display for the player of the video game.

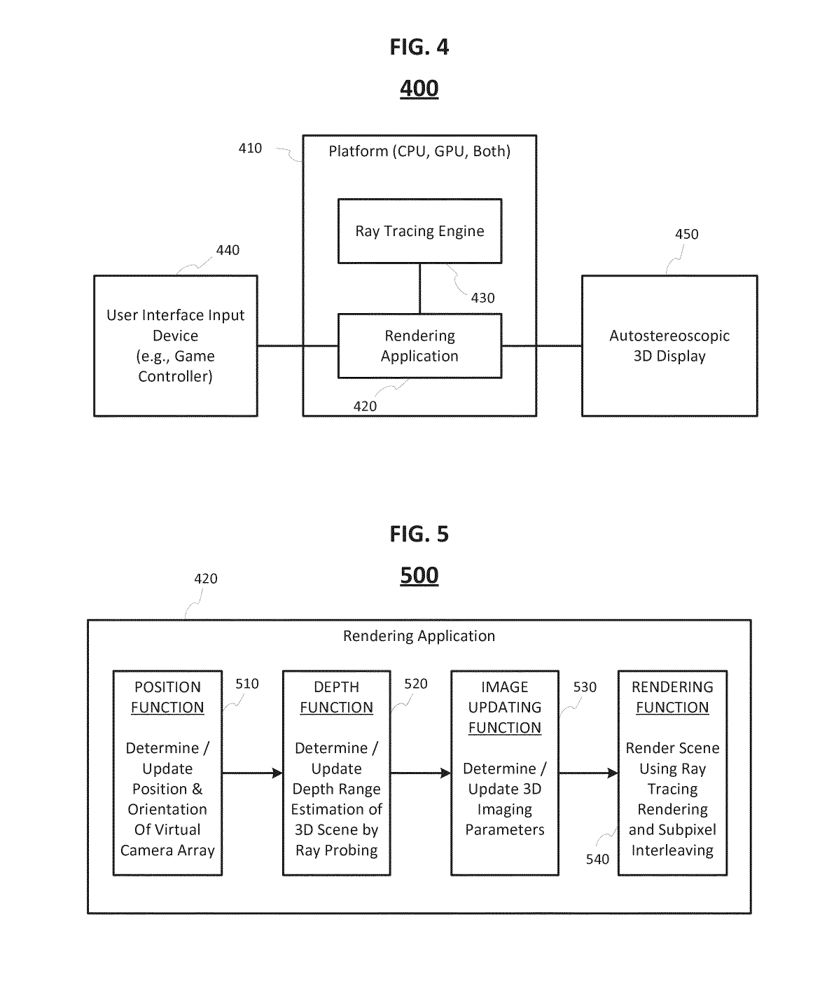

FIG. 4 illustrates one embodiment of an architecture 400 suitable to carry out embodiments of the disclosure. A computer platform 410 may include a central processing unit (CPU), a graphics processing unit (GPU), or some combination of both. The CPU and/or GPU are comprised of one or more processor circuits capable of executing instructions. A rendering application 420 may be operable on the computer platform 410. The rendering application may comprise software specifically directed toward rendering image frames representative of a 3D scene. For instance, the rendering application 420 may be used by one or more separate software applications such as, for instance, a video game to perform the image rendering functions for the video game. The embodiments are not limited in this context.

A ray tracing engine 430 may also be operable on the computer platform 410. The ray tracing engine 430 may be communicable with the rendering application 420 and provide additional support and assistance in rendering 3D image frames. In computer graphics, ray tracing is a technique for generating an image by tracing the path of light through pixels in an image plane and simulating the effects of its encounters with virtual objects. The technique is capable of producing a very high degree of visual realism, usually higher than that of typical scanline rendering methods such as rasterization. In addition, rendering by rasterization does not provide accurate depth estimation of the scene. When reflective/refractive objects are involved, the depth info from depth buffer cannot indicate the accurate range of depth of the rendered scene. Ray tracing is capable of simulating a wide variety of optical effects, such as reflection and refraction, scattering, and dispersion phenomena.

The computing platform 410 may receive input from a user interface input device 440 such as, for instance, a video game controller. The user interface input device 440 may provide input data in the form of signals that are indicative of motion within a 3D scene. The signals may comprise motion indicative of moving forward in a 3D scene, moving backward in the 3D scene, moving to the left in the 3D scene, moving to the right in the 3D scene, looking left in the 3D scene, looking right in the 3D scene, looking up in the 3D scene, looking down in the 3D scene, zooming in/out in the 3D scene, and any combination of the aforementioned. The embodiments are not limited in this context.

The computing platform 410 may output the rendered image frame(s) for a 3D scene to a display such as, for instance, an autostereoscopic 3D display device 450. An autostereoscopic 3D display device 450 may be capable of displaying stereoscopic images (adding binocular perception of 3D depth) without the use of special headgear or glasses on the part of the viewer. The embodiments are not limited in this context.

FIG. 5 illustrates a functional diagram 500 of the rendering application 420. The rendering application 420 may be generally comprised of four functions. These functions have been arbitrarily named and include a position function 510, a depth function 520, an image updating function 530, and a rendering function 540. It should be noted that the tasks performed by these functions have been logically organized. One of ordinary skill in the art may shift one or more tasks involved in the rendering process to a different function without departing from the scope of the embodiments described herein. The embodiments are not limited in this context.

The position function 510 may be responsible for determining and updating data pertaining to a virtual camera array within a 3D scene to be rendered. The virtual camera array may be indicative of the perspective and vantage point within the 3D scene. For instance, while playing a video game, the player may be represented by a character or avatar within the game itself. The avatar may be representative of the virtual camera array such that what the avatar “sees” is interpreted by the virtual camera array. The avatar may be able to influence the outcome of the game through actions taken on the user input device 440 that are relayed to the rendering application 430. The actions may be indicative of motion in the scene that alters the perspective of the virtual camera array. In camera terminology, motion left or right may be referred to as panning, motion up or down may be referred to as tilting. Thus, the position function 510 receives input from the user interface input device 440 and uses that input to re-calculate 3D scene parameters.

The depth function 520 may be responsible for determining an overall depth dimension of the 3D scene. Another aspect to rendering a 3D image may be to determine certain parameters of the 3D scene. One such parameter may be the baseline length of the virtual camera array. To determine the baseline length of the virtual camera array, an estimation of the depth range of the 3D scene may need to be determined. In rasterization rendering, the depth info may be accessed using a depth frame buffer. However, if reflective/refractive surfaces are involved in the 3D scene, more depth beyond the first encountered object by sightline must be considered. In ray-tracing rendering, one or more probe rays may be issued which travel recursively on reflective surfaces or through the reflective surfaces and return the maximum path (e.g., depth) in the 3D scene. When a probe ray hits a surface, it could generate up to three new types of rays: reflection, refraction, and shadow. A reflected ray continues on in the mirror-reflection direction from a shiny surface. It is then intersected with objects in the scene in which the closest object it intersects is what will be seen in the reflection. Refraction rays traveling through transparent material work similarly, with the addition that a refractive ray could be entering or exiting a material.

The image updating function 530 may be responsible for determining additional imaging parameters for the 3D scene. Once the depth dimension has been determined by the depth function 520, the baseline length of the virtual camera array may be determined. In addition, the image updating function 530 may also use the input received by the position function 510 to determine a focus point for the virtual camera array.

At this point the rendering application 420 may have received and processed essential data needed to construct the 3D scene. The position and orientation of the virtual camera array has been determined and an overall depth dimension for the 3D scene has been determined. The next step is for the rendering function 540 to render the 3D scene using ray tracing techniques from the vantage point of the virtual camera array and according to the parameters determined by the position function 510, depth function 520, and image updating function 530.

Ray tracing may produce visual images constructed in 3D computer graphics environments. Scenes rendered using ray tracing may be described mathematically. Each ray issued by the ray tracing engine 430 corresponds to a pixel within the 3D scene. The resolution of the 3D scene is determined by the number of pixels in the 3D scene. Thus, the number of rays needed to render a 3D scene corresponds to the number of pixels in the 3D scene. Typically, each ray may be tested for intersection with some subset of objects in the scene. Once the nearest object has been identified, the algorithm may estimate the incoming light at the point of intersection, examine the material properties of the object, and combine this information to calculate the final color of a pixel.

The rendering procedure performs sub-pixel interleaving using ray-tracing. According to the sub-pixel interleaving, the center of a pixel grouping may not necessarily be located at integer coordinates of the image plane. Unlike rendering by rasterization, ray tracing techniques may issue a ray from non-integer coordinates and the returned color components may be directly filled into a corresponding RGB pixel location without needing to perform additional interpolation procedures.

For better data locality, the ray tracing engine 430 may issue rays in an 8×8 tile group. When a frame buffer for the 3D scene being rendered is entirely filled, the current frame may be displayed with autostereoscopic 3D effect on the display 450.

The rendering time of ray-tracing is theoretically proportional to the number of rays (pixels) while the time of rasterization rendering is basically proportional to the number of views. Therefore, rendering by ray-tracing introduces very little overhead in rendering for multi-view autostereoscopic 3D displays.

Included herein are one or more flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

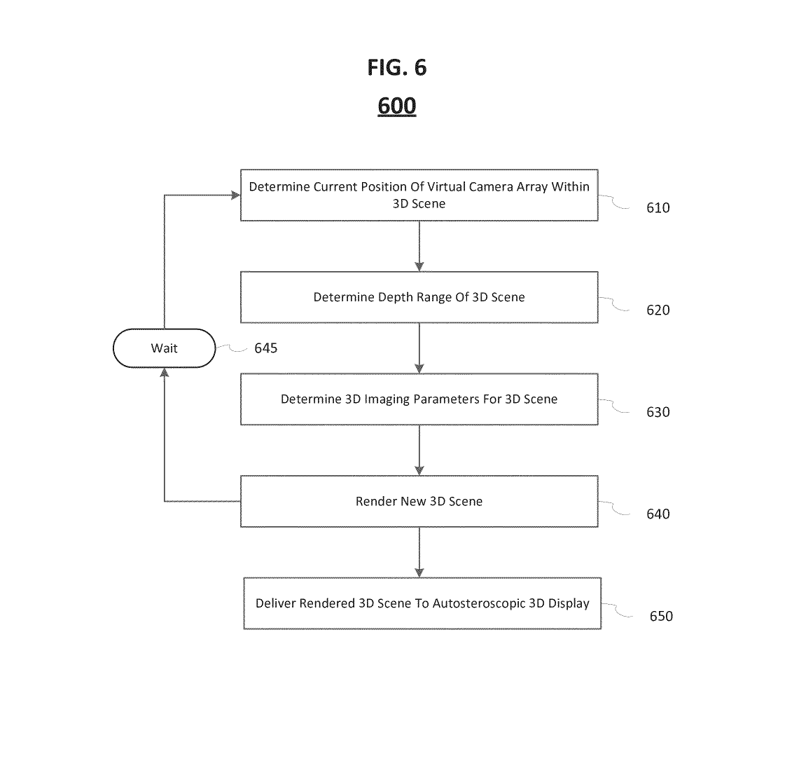

FIG. 6 illustrates one embodiment of a logic flow 600 in which a 3D scene may be rendered for an autostereoscopic 3D display according to embodiments of the invention. To render an image frame, the computer platform 410 may receive user input from a user interface input device such as a game controller. The input may be indicative of a character or avatar within a video game moving forward/backward, turning left/right, looking up/down and zooming in/out etc. This information may be used to update the position and orientation of a virtual camera array. A cluster of probe rays may be issued by the ray tracing engine 430 to obtain the depth range of the current 3D scene. 3D imaging parameters such as the baseline length and focus point of the virtual camera array may be determined using the received input information. The rendering procedure may then issue rays in 8×8 clusters or tiles. The resulting RGB color data resulting from the rays may be sub-pixel interleaved into a pixel location in a frame buffer representative of the 3D scene being rendered. When the frame buffer is entirely filled, the current frame may be displayed with autostereoscopic 3D effect. The logic flow 600 may be representative of some or all of the operations executed by one or more embodiments described herein.

In the illustrated embodiment shown in FIG. 6, the logic flow 400 may determine a current position of a virtual camera array at block 610. For example, the CPU 110 may be executing the rendering application 420 such that input data may be received from the user interface input device 440. The virtual camera array may be indicative of the perspective and vantage point (e.g., orientation) within the 3D scene. The vantage point may have changed since the last frame due to certain actions taken. The actions may be indicative of motion in the 3D scene that alters the perspective of the virtual camera array. The user interface input device 440 may forward signals to the rendering application 420 consistent with a user's actions. For example, a user may move forward or backward within the 3D scene, move left or right within the 3D scene, look left or right within the 3D scene, look up or down within the 3D scene, and zoom in or out within the 3D scene. Each action may change the perspective of the 3D scene. The rendering application uses the data received from the user input interface 440 to assist in determining a new position and orientation of the virtual camera array within the 3D scene. The embodiments are not limited in this context.

In the illustrated embodiment shown in FIG. 6, the logic flow 400 may determine a depth range of the 3D scene at block 620. For example, to determine the baseline length of the virtual camera array, an accurate estimation of the depth range of the 3D scene may need to be determined. The ray tracing engine 430 may issue one or more probe rays that travel recursively on reflective surfaces or through reflective surfaces within the 3D scene and return the maximum path (e.g., depth) in the 3D scene. The embodiments are not limited in this context.

In the illustrated embodiment shown in FIG. 6, the logic flow 400 may determine imaging parameters for the 3D scene at block 630. For example, the baseline length of the virtual camera array and the focus point of the virtual camera array may be determined. Once the depth dimension has been determined, the baseline length of the virtual camera array may be determined. In addition, the input received at block 610 may be used to determine a focus point and orientation for the virtual camera array. The rendering application 420 in conjunction with the ray tracing engine 430 may process the input received at block 610 and the depth range determined at block 620 to determine the baseline length of the virtual camera array and the focus point for the virtual camera array. The embodiments are not limited in this context.

In the illustrated embodiment shown in FIG. 6, the logic flow 400 may render the new 3D scene at block 640. For example, the rendering application 420 in conjunction with the ray tracing engine 430 may issue multiple rays from the updated position and orientation of the virtual camera array determined at blocks 610, 620, and 630. Each ray issued by the ray tracing engine 430 corresponds to a pixel within the 3D scene. The resolution of the 3D scene is determined by the number of pixels in the 3D scene. Thus, the number of rays needed to render a 3D scene corresponds to the number of pixels in the 3D scene. Typically, each ray may be tested for intersection with some subset of objects in the scene. Once the nearest object has been identified, the algorithm may estimate the incoming light at the point of intersection, examine the material properties of the object, and combine this information to calculate the final color of a pixel. The rendering procedure performs sub-pixel interleaving using ray-tracing. According to the sub-pixel interleaving, the center of a pixel grouping may not necessarily be located at integer coordinates of the image plane. Ray tracing techniques may issue a ray from non-integer coordinates and the returned color components may be directly filled into a corresponding RGB pixel location without needing to perform additional interpolation procedures. For better data locality, the ray tracing engine 430 may issue rays in an 8×8 tile group. The embodiments are not limited in this context.

Upon completing the ray tracing rendering process for the current frame, the rendering application 420 will return control to block 610 to repeat the process for the next frame. There may be a wait period 645 depending on the frame rate that the rendering application 420 is using.

In the illustrated embodiment shown in FIG. 6, the logic flow 400 may deliver the rendered frame indicative of the new 3D scene to a display at block 650. For example, the rendering application 420 may forward the image frame representing the current view of the 3D scene to a display 450. When a frame buffer for the entire 3D scene being rendered is filled, the current frame may be displayed with autostereoscopic 3D effect on the display 450. The embodiments are not limited in this context.

In one experiment, a ray tracing engine was used to test the rendering performance for a combination of different resolutions and a different number of views for an autostereoscopic 3D display. A video game, specifically its starting scene, were used as test frames. The hardware platform used twenty-four (24) threads to run the ray tracing engine. In Table 1 below, the “Original” row refers to the ray tracing engine's performance for rendering the 2D frame. The “Interleaving by rendering” rows implement the procedures described above (e.g., issuing rays and filling the result color immediately). In order to provide better data locality, a tile of 8×8 rays was issued and a tile of 8×8 were filled pixels at once. It can be seen that for the 1-view case of interleaving by rendering, the performance is very close to the “original” while the 8-view interleaving by rendering case only introduces 47% performance loss for HD resolution. The last row “Interleaving after rendering” refers to rendering all 8 view images and then doing the sub-pixel interleaving. This causes 65% performance loss because it requires an extra buffer to store intermediate view images.

TABLE 1

| | | | 1920 × 1080 | Performance |
|---|---|---|---|---|
| | | 1024 × 868 | (HD) | Loss in HD |
| Original (2D rendering) | | 58 ms | 97 ms | |
| Interleaving by | 1 - view | 61 ms | 101 ms | −4% |
| rendering | 8 - view | 116 ms | 133 ms | −37% |

| | | | |
|---|---|---|---|
| Interleaving after | 108 ms | 160 ms | −65% |
| rendering, 8 - view | | | |

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

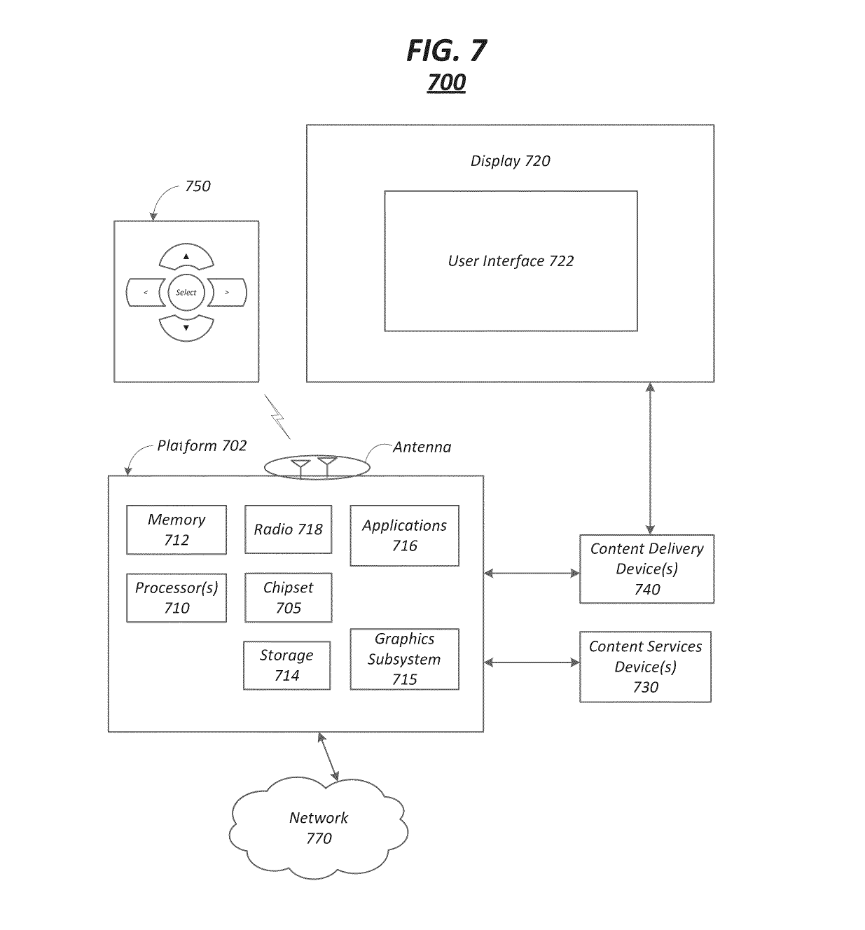

FIG. 7 illustrates an embodiment of a system 700 that may be suitable for implementing the ray tracing rendering embodiments of the disclosure. In embodiments, system 700 may be a system capable of implementing the ray tracing embodiments although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, gaming system, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor(s) 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor(s) 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor(s) 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 6.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

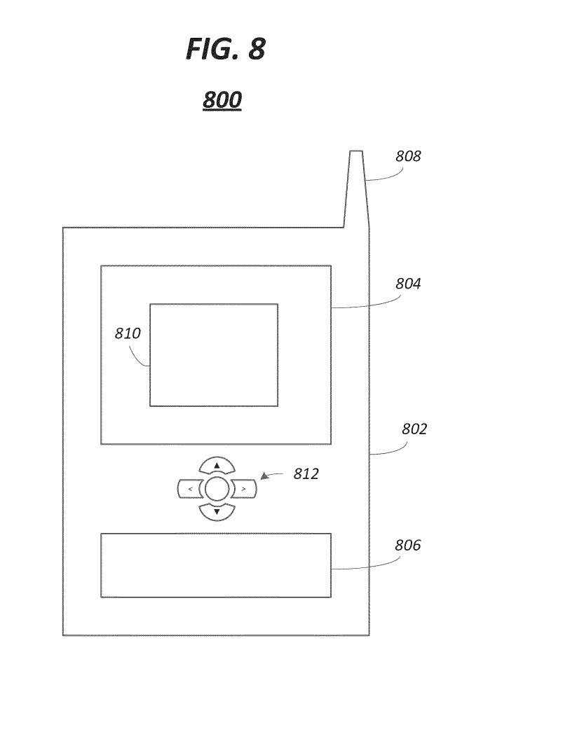

As described above, system 700 may be embodied in varying physical styles or form factors. FIG. 8 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, gaming device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Embodiments may also be at least partly implemented as instructions contained in or on a non-transitory computer-readable medium, which may be read and executed by one or more processors to enable performance of the operations described herein.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus comprising:
a processor circuit;
a rendering application operative on the processor circuit to:
determine a position and orientation of a virtual camera array within a three-dimensional (3D) scene to be rendered on an autostereoscopic 3D display; and
determine at least one additional 3D imaging parameter for the 3D scene, and a ray tracing engine operative on the processor circuit to:
determine a depth range for the 3D scene; and
render an image frame representative of the 3D scene.

2. The apparatus of claim 1, the ray tracing engine operative on the processor circuit to render an image frame representative of the 3D scene for a multi-view autostereoscopic 3D display.

3. The apparatus of claim 1, the ray tracing engine operative on the processor circuit to:
issue a ray into the 3D scene at a known location;
calculate a pixel color corresponding to the issued ray for the known location,
associate the pixel color with a pixel for the known location in a frame buffer, the frame buffer containing pixel image data representative of the 3D scene.

4. The apparatus of claim 3, wherein the pixel color includes red (R), green (G), and blue (B) (RGB) sub-pixel components.

5. The apparatus of claim 1, the rendering application operative on the processor circuit to:
receive input from a user interface input device, the input pertaining to the position and orientation of the virtual camera array.

6. The apparatus of claim 5, wherein the input includes a data signal representative of motion since a last frame was rendered, the motion including:
forward motion within the 3D scene;
backward motion within the 3D scene;
motion to the left within the 3D scene;
motion to the right within the 3D scene;
upwards motion within the 3D scene;
downwards motion within the 3D scene;
panning motion for the virtual camera array within the 3D scene;
tilting motion for the virtual camera array within the 3D scene; and
zooming adjustments for the virtual camera array within the 3D scene.

7. The apparatus of claim 6, wherein the user interface input device comprises a game controller.

8. The apparatus of claim 1, the ray tracing engine operative on the processor circuit to:
issue multiple probe rays into the 3D scene; and
determine the depth of the 3D scene based on the multiple probe rays.

9. The apparatus of claim 1, the rendering application operative on the processor circuit to:
determine a baseline length of the virtual camera array; and
determine a focus point of the virtual camera array.

10. A method, comprising:
determining a position and orientation of a virtual camera array within a three-dimensional (3D) scene to be rendered on an autostereoscopic 3D display;
determining a depth range for the 3D scene;
determining at least one additional 3D imaging parameter for the 3D scene; and
rendering an image frame representative of the 3D scene using a ray tracing process.

11. The method of claim 10, comprising rendering the image frame representative of the 3D scene for a multi-view autostereoscopic 3D display.

12. The method of claim 10, wherein rendering the 3D scene comprises:
issuing a ray into the 3D scene at a known location;
calculating a pixel color corresponding to the issued ray for the known location,
associating the pixel color with a pixel for the known location in a frame buffer, the frame buffer containing pixel image data representative of the 3D scene.

13. The method of claim 12, wherein the pixel color includes red (R), green (G), and blue (B) (RGB) sub-pixel components.

14. The method of claim 10, wherein determining the current orientation of the virtual camera array comprises:
receiving input pertaining to a position and orientation of the virtual camera array since a last frame was rendered, the input including data representative of:
forward motion within the 3D scene;
backward motion within the 3D scene;
motion to the left within the 3D scene;
motion to the right within the 3D scene;
upwards motion within the 3D scene;
downwards motion within the 3D scene;
panning motion for the virtual camera array within the 3D scene;
tilting motion for the virtual camera array within the 3D scene; and
zooming adjustments for the virtual camera array within the 3D scene.

15. The method of claim 10, wherein determining the depth range for the 3D scene comprises:
issuing multiple probe rays into the 3D scene; and
determining the depth of the 3D scene based on the multiple probe rays.

16. The method of claim 10, wherein determining the at least on additional 3D imaging parameter for the 3D scene comprises:
determining a baseline length of the virtual camera array; and
determining a focus point of the virtual camera array.

17. At least one computer-readable storage medium comprising instructions that, when executed, cause a system to:
determine a position and orientation of a virtual camera array within a three-dimensional (3D) scene to be rendered on an autostereoscopic 3D display;
determine a depth range for the 3D scene;
determine at least one additional 3D imaging parameter for the 3D scene; and
rendering an image frame representative of the 3D scene using a ray tracing process.

18. The computer-readable storage medium of claim 17 containing instructions that when executed cause a system to render the image frame representative of the 3D scene for a multi-view autostereoscopic 3D display.

19. The computer-readable storage medium of claim 17 containing instructions that when executed cause a system to:
issue a ray into the 3D scene at a known location;
calculate a pixel color corresponding to the issued ray for the known location,
associate the pixel color with a pixel for the known location in a frame buffer, the frame buffer containing pixel image data representative of the 3D scene.

20. The computer-readable storage medium of claim 19, wherein the pixel color includes red (R), green (G), and blue (B) (RGB) sub-pixel components.

21. The computer-readable storage medium of claim 17 containing instructions that when executed cause a system to receive input pertaining to a position and orientation of the virtual camera array since a last frame was rendered.

22. The computer-readable storage medium of claim 21, wherein the input includes data representative of:
forward motion within the 3D scene;
backward motion within the 3D scene;
motion to the left within the 3D scene;
motion to the right within the 3D scene;
upwards motion within the 3D scene;
downwards motion within the 3D scene;
panning motion for the virtual camera array within the 3D scene;
tilting motion for the virtual camera array within the 3D scene; and
zooming adjustments for the virtual camera array within the 3D scene.

23. The computer-readable storage medium of claim 17 containing instructions that when executed cause a system to:
issue multiple probe rays into the 3D scene; and
determine the depth of the 3D scene based on the multiple probe rays.

24. The computer-readable storage medium of claim 17 containing instructions that when executed cause a system to:
determine a baseline length of the virtual camera array; and
determine a focus point of the virtual camera array.
